(19) United States
(12) Patent Application Publication
(10) Pub. No.: US 2011/0293880 A1
(43) Pub. Date: Dec. 1, 2011

(54) BAMBOO ARTIFICIAL BOARD AND PRODUCING METHOD THEREOF

(76) Inventors: Yanglun Yu, Beijing (CN); Wenji Yu, Beijing (CN); Yue Zhou, Beijing (CN); Rongxian Zhu, Beijing (CN); Dinghua Ren, Beijing (CN); Zhiying Su, Beijing (CN)

(21) Appl. No.: 13/201,279

(22) PCT Filed: Feb. 11, 2010
(86) PCT No.: PCT/CN10/70655

§ 371 Date: Aug. 12, 2011

(30) Foreign Application Priority Data
Feb. 13, 2009 (CN) 200920105909.8
Feb. 13, 2009 (CN) 200920105913.4
Feb. 20, 2009 (CN) 200910078222.4
Jul. 27, 2009 (CN) 200910089637.1

(51) Int. Cl. B32B 7/12; E04C 2/10; B27J 7/00; B32B 21/08

(52) U.S. Cl. 428/106; 428/114; 144/333

(57) ABSTRACT

The present invention provides a bamboo-based panel comprising a hunk bamboo bundle mat based panel and a bamboo fiber reinforced composite. The bamboo-based panel comprises several pieces of the hunk bamboo bundle mats or oriented bamboo fiber mats (OBFM) which are parallel or cross laid up with each other, the glue layer is arranged among them so as to make panels by gluing. The upper surface and the lower surface of said hunk bamboo bundle mat comprise the outer layer and inner layer of said bamboo, wherein, a waxy layer and a siliceous layer are respectively removed therefrom.

### FIELD OF THE INVENTION

The present invention relates to wood-based panels. The present invention provides a bamboo-based panel and a method for manufacturing bamboo-based panels thereof. In particular, the said panel is applied to the field of structural and decorative materials which are with the requirement of high strength, high hardness and good processing performance, such as wind turbine blades materials, building structural materials, construction formwork, compartment flooring, decorative materials, furniture, flooring and so on.

### BACKGROUND OF THE INVENTION

Since bamboos have such advantages as fast growth, high strength and toughness, it is widely used in producing bamboo-based panels. According to the varieties of raw materials, the geometry of component units and the structure of panels, the bamboo-based panels can be divided into 5 categories: bamboo plywood, laminated bamboo lumber, bamboo particle board, bamboo scrimber and wood-bamboo composite panel, and the component unit is a very important section of manufacturing said bamboo-based panel. At present, the component units of the bamboo-based panels are mainly the bamboo strips, bamboo curtain and bamboo mat woven from bamboo strips, bamboo sheet, bamboo bundle, and so on. The above component units of said bamboo are long strip structural units obtained by splitting the bamboos. Because the outer layer and the inner layer of said bamboo are hard to be glued and show large different physical and mechanical properties compared with the main part of said bamboo, when the above structural units are used in manufacturing panels, the inner layer and outer layer of said bamboo must be removed in the process of structural unit so as to meet the physical and mechanical properties of said bamboo-based panels. For the bamboos with a large diameter and a thicker bamboo wall, such as Phyllostachys pubescens, the outer layer and inner layer of said bamboo accounts for 15% to 20% of said bamboo wall thickness; However for the miscellaneous bamboos with a smaller diameter and a thinner bamboo wall, the outer and inner layer of said bamboo can account for about 50% of the bamboo wall thickness. Only the Phyllostachys pubescens can be widely used in large-scale industrial applications in China, but the yield of Phyllostachys pubescens is only about 20% to 30% of the bamboo yield in China, the bamboo with a smaller diameter and the miscellaneous bamboo with a larger diameter such as Bambusa dendrocalamopsis olddarrrrrii, Dendrocalamus, and so on, which account for 70% to 80% of the total bamboo output, have not been used in large-scale industrial applications. In view of these facts, the Chinese patent CN 02120518.3 provides a method for manufacturing the smaller diameter bamboos with the diameter less than 80 mm. The production processes are as follows: removing the outer layer of said bamboo by the removal apparatus or the sandblasting apparatus; splitting the bamboo culms into semicircular bamboo tubes with a bamboo-splitting machine; rolling the semicircular bamboo tube into horizontal continuous, longitudinal loose and cross linked bamboo bundles by the bamboo rolling machine. Although the utilization of said bamboo is increased in the above method, the production efficiency is low because the method for removing the outer layer of said bamboo is somehow complex, and wherein, the inner layer of said bamboo is not removed; what's more, the bundles rolled by said bamboo are with uneven thickness, varying lengths, and it is different for the bundles to distribute uniformly, then the sizing and the moisture content are not distributed uniformly too. Actually, the increase of the strength and hardness of the pressed plywood is limited.

### SUMMARY OF THE INVENTION

The object of the present invention is to improve the existing technology, and further the invention provides a bamboo-based panel made by hunk bamboo bundle mats and a bamboo fiber reinforced composite made by an oriented bamboo fiber mat (OBFM).

Another object of the present invention is to provide a method for manufacturing the bamboo-based panels.

The objects of the present invention can be achieved as follows:

The present invention provides a bamboo-based panel made by the hunk bamboo bundle mat, which comprises several layers of the hunk bamboo bundle mats with the width of 50 to 600 mm. Wherein the adjacent bamboo bundles are assembled with parallel or cross structure along the grain direction, the glue layers are arranged between the adjacent hunk bamboo bundle mats and between the bamboo bundles of the hunk bamboo bundle mat so as to make bamboo-based panels glued. For said oriented hunk bamboo bundle mat, a series of dotted and/or linear shaped cracks are formed on the cylinder wall of a semicircular bamboo tube which is split and inner nodes are removed from so as to form a netty structural oriented hunk bamboo bundle mat which is composed of interlaced bundles; said hunk bamboo bundle mat comprises the outer layer, the main part and the inner layer of said bamboo, and the upper surface and the lower surface of said hunk bamboo bundle mat comprise the outer layer and inner layer of said bamboo, wherein, a waxy layer and a siliceous layer are respectively removed therefrom.

The width of said hunk bamboo bundle mat is 2 to 5 times the arc length of said semicircular bamboo tube according to the density of cracks in said hunk bamboo bundle mat.

The bamboo bundles are formed between the adjacent cracks, and the diameter of said bamboo bundles is 0.10 to 5 mm.

If the said adhesive used in the glue layer is phenolic-formaldehyde resin, the glue spread amount is 8% to 40% of the oven dry weight of the hunk bamboo bundle mat.

If the said adhesive used in the glue layer is isocyanate resin, the glue spread amount is 5% to 20% of the oven dry weight of the hunk bamboo bundle mat.

The present invention also provides a bamboo fiber reinforced composite, which is composed of oriented bamboo fiber mats and glue layers. Serial longitudinal and discontinuous cracks with uneven thickness are distributed on the upper surface, lower surface and bamboo wall of the oriented bamboo fiber mats. The glue layers are arranged among the cracks and on the surfaces of said bamboo fiber mats.

Within the oriented bamboo fiber mat of said bamboo fiber reinforced composite, the fibers are formed between the adjacent said cracks, and said fiber contains 1˜5 vascular bundles and several ground tissues.

Said bamboo-based panels comprise the bamboo-based panel made by the hunk bamboo bundle mat and the bamboo fiber reinforced composite.

A method for manufacturing said bamboo-based panel made by the hunk bamboo bundle mat comprises the following steps:

A. the hunk bamboo bundle mat preparation
wherein the bamboo is sawn into a bamboo tube with the length of 1.5 to 20 m, which is then longitudinally split into two semicircular bamboo tubes, after the inner nodes are removed, the semicircular bamboo tube is pushed into the fluffer along the grain direction, the bamboo tube is fluffed along the longitudinal fiber direction to form a series of dotted and/or linear shaped cracks along the fiber direction; the bundles with connection part and separation part between them are formed, and the netty structural hunk bamboo bundle mat is formed by the interlaced bamboo bundles, which comprise the main part, outer layer and inner layer of said bamboo, and the upper surface and the lower surface of said hunk bamboo bundle mat comprise the outer layer and the inner layer of said bamboo, wherein, a waxy layer and a siliceous layer are respectively removed therefrom;
B. drying
wherein said hunk bamboo bundle mat is dried until the moisture content is a range of 8 to 15%;
C. glue spreading
wherein the glue is spread on the said hunk bamboo bundle mat;
D. assembling
wherein the said glued hunk bamboo bundle mats are weighed out according to the designed density, and then assembled;
E: curing forming
wherein put the hunk bamboo bundle mats assembled in the above step in the press or oven to form the bamboo-based panels.

Specifically, during the said glue spreading process,

if the used adhesive is isocyanate adhesive, the spray glue method will be used, wherein, the glue spread amount is 5% to 20% of the oven dry weight of said hunk bamboo bundle mats, and the above isocyanate adhesive is sprayed uniformly on both outer layer and inner layer of hunk bamboo bundle mats according to the above glue spread amount.

If the adhesive is phenolic-formaldehyde adhesive, the dipping glue method will be used, wherein, the solid content of the phenol-formaldehyde is 8% to 40% of the oven dry weight of said hunk bamboo bundle mats; the solid content of the phenol-formaldehyde is 8% to 30%; the temperature of the glue solution should be normal temperature while dipping glue, and the dipping glue time is 5 to 20 min; then the glued hunk bamboo bundle mats are taken out and placed vertically for 5 to 20 min until the adhesive stop dipping.

During the Assembling Procedure:

the slab laying up: the hunk bamboo bundle mats are weighed out according to the designed density, if the hot-pressing method is used, the glued hunk bamboo bundle mats in adjacent layers are assembled with parallel or cross structure and then hot pressed;
if the cold-pressing and hot-curing method is used, the glued hunk bamboo bundle mats are assembled along the bamboo grain direction i.e., the hunk bamboo bundle mat in each layer is assembled as parallel to the grain direction of the bamboo bundle, and then laid up in the mould. The laid up slab and mould are put into the press, after the mould is pressed to the designed position, the mould is fixed with pins, wherein the cold pressure is 10 to 15 MPa, and the temperature is room temperature.

If the said adhesive is isocyanate adhesive, the release agent is used to daub on the hot platen of the press or the mould.

In the said forming process, hot-pressing curing and drying-curing can be applied.

In the hot-pressing curing process, said used adhesive can be either phenolic-formaldehyde adhesive or isocyanate adhesive. If the said adhesive is phenolic-formaldehyde resin, the solid content and glue spread amounts are 8% to 30%, the hot-pressing time is 0.5 to 2 min/mm, the hot-pressing pressure is 5 to 15 MPa, and the hot-pressing temperature is 130° C.˜180° C. If the said adhesive is isocyanate resin, the glue spread amount is 5 to 20%, the hot-pressing time is 0.5 to 1.2 min/mm, the hot-pressing temperature is 90° C.˜130° C., and the hot-pressing pressure is 5 to 20 MPa.

In the above drying-curing process, the used adhesive can be either phenolic-formaldehyde resin or isocyanate resin. If the said adhesive is phenolic-formaldehyde resin, the solid content and glue spread amount are 8 to 30%, the above slab with mould is sent into the oven with the temperature of 120 to 180° C., and the curing time is 2 to 4 h. If the said adhesive is isocyanate resin, the glue spread amount is 5 to 20%, the above slab with mould is sent into the oven with the temperature of 90 to 140° C., and the curing time is 1.5 to 3.5 h.

The process for manufacturing the bamboo fiber reinforced composites comprises the following steps:

1) The bamboos such as Phyllostachys pubescens, Dendrocalamus sinicus, Dendrocalamopsis oldhami, Neosinocalanius affinis, Dendrocalamus laaflorus, Phyllostachys praecox and Phyllostachys viridis are used as raw materials, the bamboo is sawn into a bamboo tube with the length of 1.5 to 20 m, which is then longitudinally split into semicircular bamboo tubes along the diameter, and the inner nodes of the semicircular bamboo tube are removed;
2) the inner arc surface fluffing
wherein on end of the semicircular bamboo tube is pushed into the clearance between driving roller and fluffing roller with its inner surface towards the fluffing roller, while the driving roller is dragging the semicircular bamboo tube parallelly forward, discontinuous fibration cracks are arranged uniformly on the inner arc surface by the local longitudinal cutting and transversal extruding of the different position in the inner arc surface of said semicircular bamboo tube, however, the outer surface of the semicircular bamboo tube still keeps with relatively complete piece-shape structure, meanwhile, the siliceous layer in the inner surface of semicircular bamboo tubes is cut and extruded by the fluffing roller to make the siliceous layer to shed automatically as shape of crack, fragment or granule, with the above method, said semicircular bamboo tube is fluffed for several times;
3) the outer arc surface fluffing
wherein said semicircular bamboo tube with fluffed inner arc surface turns 180 degrees, which is pushed into the clearance between the driving roller and fluffing roller with the outer surface towards above-mentioned fluffing roller or the fluffing roller of the same fluffer as the above, with the same procedure as step 2), a series of discontinuous fibration cracks are arranged uniformly on the corresponding outer arc surface of the semicircular bamboo tube, meanwhile, the waxy layer in the outer surface of semicircular bamboo tubes is cut and extruded by the fluffing roller to make the shape of crack, fragment or granule, with the above method, said semicircular bamboo tube is fluffed for several times;
4) drying
wherein the said fluffed oriented bamboo fiber mat is dried in the oven until the moisture content is 8 to 15%;
5) glue spreading
if the said adhesive is phenolic-formaldehyde resin, the solid content is 15%, the glue spread amount is 12% of the oven dry weight of the oriented bamboo fiber mat with dipping glue process; the temperature of the glue solution is normal temperature while dipping, and the dipping time is 6 min; after the glued oriented bamboo fiber mats (OBFM) are taken out and placed vertically for 6 min until the adhesive on the surface stops dropping, then the glued oriented bamboo fiber mats (OBFM) are dried in 40° C. oven until the moisture content is 12%;
6) assembling
wherein the veneers of said bamboo fiber reinforced composite are weighed out according to the designed density, and the above glued veneers of the bamboo fiber reinforced composite are assembled along the grain direction with the outer layer outward and the inner surface inward so as to form the slab;
7) hot-pressing
wherein the cold-in and cold-out technology is used in the hot-pressing process, when the temperature of the hot platen is in a range of 40 to 60° C., the above slab is sent into the press; the superheated vapor is introduced, and the pressure is increasing with the increasing temperature; when the pressure is 3.5 Mpa, the pressure is kept, and when the temperature is 160° C., the temperature is kept, and the holding time of the temperature is 0.5 min/min; then the cold water is introduced into the press to decrease the temperature to 40 to 60° C., the pressure is released, and the slab is taken out from the press to obtain the needed assembly product of several bamboo fiber reinforced composites.

The bamboo bundles are formed between said adjacent fibration cracks, and the diameter of said bamboo bundles is in a range of 0.05 to 5 mm.

The surface of said driving roller has uniform convex pocks.

The length of the fluffing teeth is 1.1 to 1.3 times the longitudinal distance between the two teeth. The height of said fluffing teeth is 0.5 to 0.75 times the wall thickness of the semicircular bamboo tube.

The width of said oriented bamboo fiber mat extends to 2 to 5 times the arc length of the semicircular bamboo tube.

The bamboo-based panels provided by the present invention are composed of the hunk bamboo bundle mat and the oriented bamboo fiber mat, (OBFM) which are with the outer layer and inner layer of said bamboo and made by fluffing directly the split bamboo tube. The bamboo-based panels with good performance are made through the special glue spreading and forming method. In the present invention, a number of the small-diameter bamboo which can't be utilized with the existing technology can be fully used, the process becomes easier and the production efficiency is increased.

### DETAILED DESCRIPTION OF THE DRAWINGS

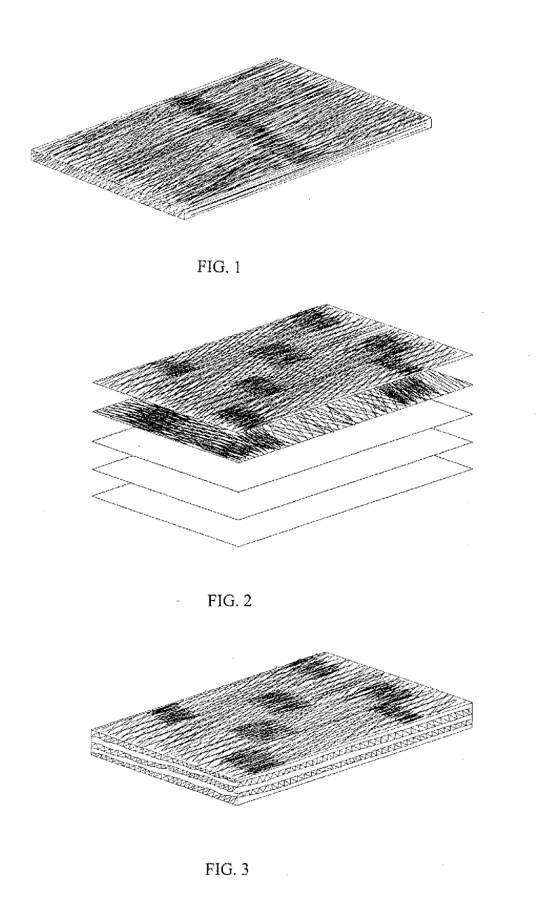

FIG. 1 is the structure diagram of the hunk bamboo bundle mat for the bamboo-based panels according to the present invention;

FIG. 2 is the structure diagram of several hunk bamboo bundle mats which are perpendicularly laid up together before forming the panel;

FIG. 3 is the structure diagram of said bamboo-based panels formed by pressing several hunk bamboo bundle mats which are cross laid up;

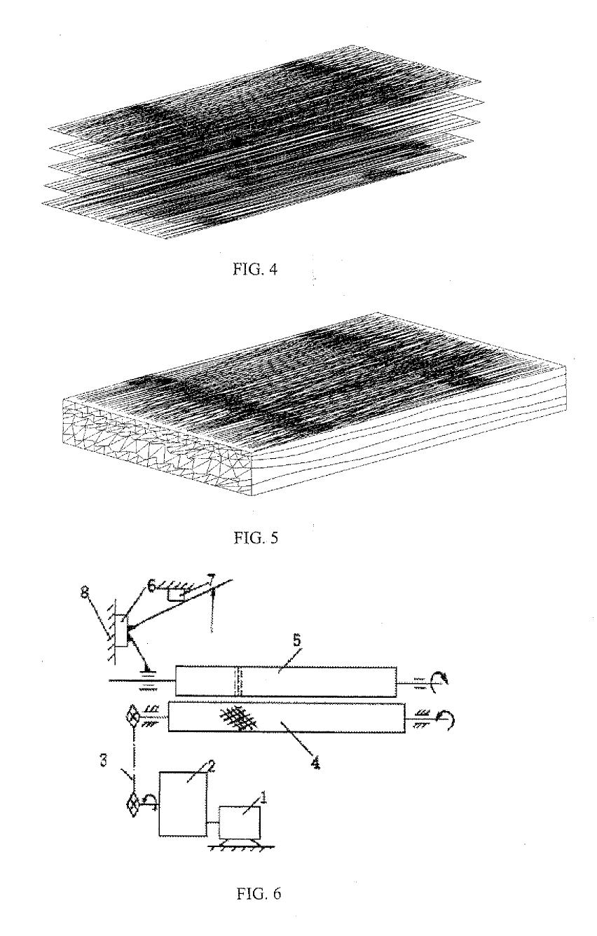

FIG. 4 is the structure diagram of several hunk bamboo bundle mats which are parallel laid up together before forming the panel;

FIG. 5 is the structure diagram of the bamboo-based panel formed by pressing several hunk bamboo bundle mats which are paralel laid up together;

FIG. 6 is the structure diagram of the fluffer for manufacturing hunk bamboo bundle mat;

FIG. 7a is the structure diagram of the special shaped gear arranged on the fluffing roller of said fluffer as shown in FIG. 6;

FIG. 7b is the side view of said special shaped gear as shown in FIG. 7a;

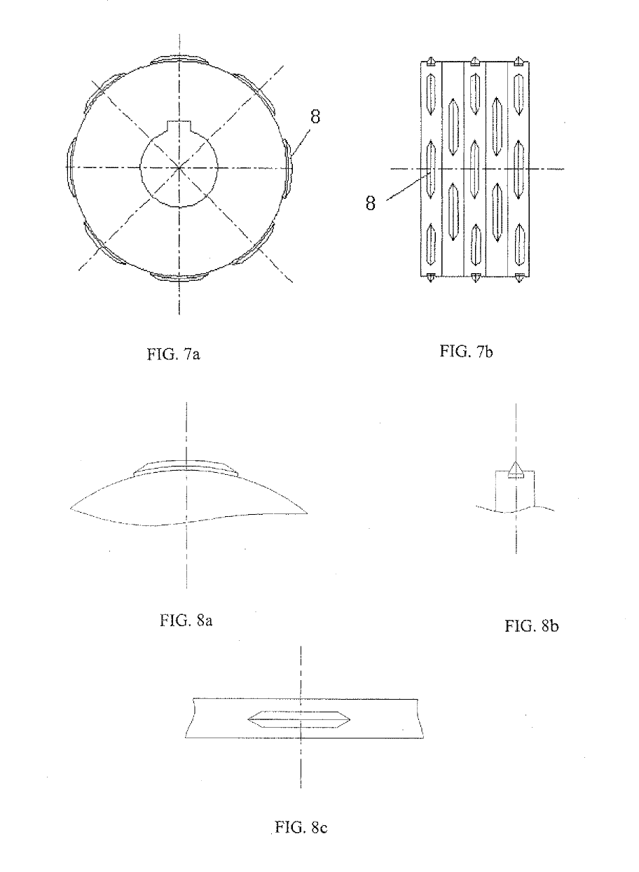

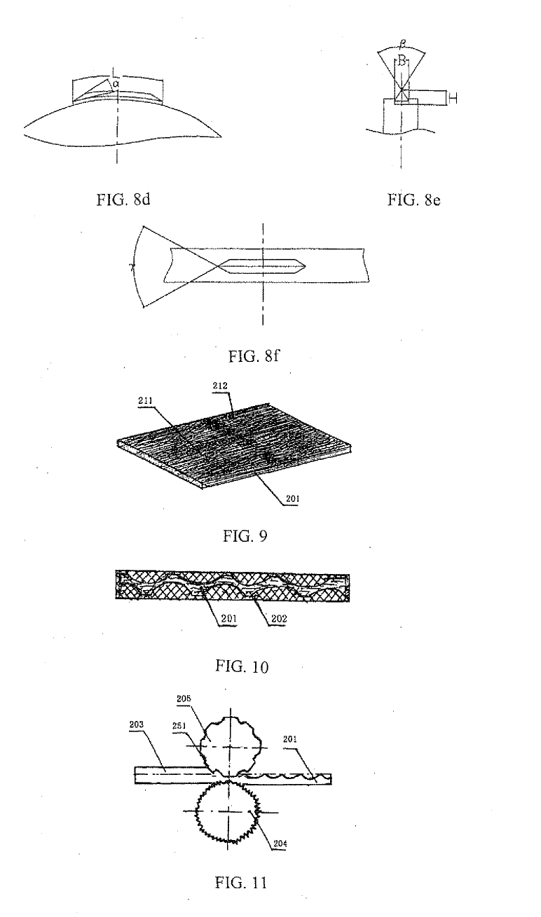

FIG. 8a is the structure diagram of the fluffing teeth on the special shaped gear as shown in FIGS. 7a and 7b;

FIG. 8b is the side view of the fluffing teeth as shown in FIG. 8a;

FIG. 8c is the top view of the fluffing teeth as shown in FIG. 8a;

FIG. 8d is the structure diagram of tooth bevel angle α on the fluffing tooth;

FIG. 8e is the structure diagram of tooth tip angle β on the fluffing tooth;

FIG. 8f is the structure diagram of tooth angle γ on the fluffing tooth;

FIG. 9 is the stereogram of oriented bamboo fiber mat (OBFM) in the typical examples of the present invention;

FIG. 10 is the cutaway view of said bamboo fiber reinforced composites in the typical examples of the present invention;

FIG. 11 is the schematic diagram of the fluffer in the typical examples of the present invention.

### EMBODIMENT

### Example 1

The bamboos such as Phyllostachys pubescens, Dendrocalamus sinicus and Dendrocalamopsis oldhami are used to make Bamboo scrimber, the specific implementation steps as follows:

A: the hunk bamboo bundle mat preparation
wherein the large-diameter and thick-wall bamboo such as Phyllostachys pubescens, Dendrocalamus sinicus and Dendrocalamopsis oldhami are used to manufacture bamboo-based panels;
the bamboo is sawn into a 2.5 m or 1.3 m bamboo tube which is then split into two semicircular bamboo tubes along the diameter, the semicircular bamboo tube is pushed into the fluffer to fluffer the inner layer of said bamboo; the structure of the fluffer is as shown in FIG. 6, said fluffer includes the driving roller 4 and fluffing roller 5 with a certain clearance between them, the driving roller 4 and fluffing roller 5 can be rotary and fixed horizontal on the support frame, said driving roller 4 connects with said motor 1 by decelerator; several fluffing teeth are distributed in the circumferential direction of said fluffing roller 5, the cutting edges are arranged in said fluffing teeth and extends alternately in the circumferential direction of said fluffing roller, and the drum of the fluffing roller is axially distributed with several rows of said cutting edges are distributed along the axial direction of the fluffing roller; specifically, the motor 1 drives the driving roller shafting, i.e., the driving roller 4, to actively rotate through the main decelerator 2 and chain transmission device 3; the fluffing roller 5 connects with the support frame 6, and the height of the fluffing roller is adjusted through adjusting the pad 7 to change the radial distance between said driving roller 4 and said fluffing roller 5, once the distance is confirmed, the fluffing roller 5 becomes the rigidity support; during the process of fluffing, the friction between the bamboo and driving roller 4 drives the bamboo into the clearance between the driving roller 4 and fluffing roller 5, then the moving bamboo drives the fluffing roller 5 to rotate at the same time. The circumference and special shaped convex fluffing teeth 8 are distributed uniformly and staggeredly on the circumferential surface of the fluffing roller 5;
as shown in FIGS. 6, 7a, 7b, 7c, 7d and 8a to 8f, said fluffing roller 5 is composed of special gear shafting, said special gear shafting includes a gear shaft with locking screw on its two ends and several staggeredly assembled special shaped gears which are fixed on the gear shaft with keys, several fluffing teeth are distributed uniformly on the circumferential direction of the said special shaped gears, the bond angles between adjacent special shaped gears have a 22.5° difference with each other; said driving roller 4 surface is a twist roller with knurling on the roller surface, the knurling can increase the friction; as shown in FIGS. 8a to 8f, the arc length of said fluffing teeth is 2 times the gap length between the teeth; the diameter of said fluffing roller is 138 mm, the diameter of said driving roller is 2 times that of said fluffing roller; the thickness of said special shaped gear is 5 mm, the perpendicular distance between the teeth tips of two adjacent fluffing teeth is 5 mm, the height of the fluffing teeth is 3 mm; the tooth tip angle is 90°, the tooth angle γ is 60°, and the tooth bevel angle α is 45°; the driving roller is convex roller;
the semicircular bamboo tube is pushed into the fluffer with the inner surface towards the fluffing roller and the outer surface towards the driving roller; after fluffing for 2 times, a series of dotted and/or linear shaped cracks and radial spreading are made on the inner surface by longitudinal cutting and transverse spreading, however, the outer surfaces still keep relatively completed piece-shape structure, then the structure of semicircular bamboo tubes is converted from the structure with the outer and inner surface of said bamboo as outer arc and inner arc surface respectively into the structure with the inner surface and outer surface of said bamboo as outer arc and inner arc surface respectively; the said semicircular bamboo is pushed into the fluffer with the outer surface towards the fluffing roller and the inner surface towards the driving roller, after the fluffing repeated for 2 times, the arc structures of the hunk bamboo bundle curtain faces towards the inner layer of said bamboo again with the further increase of the fluffing degree of the outer layer; repeating above alternate fluffing for 3 times, the fluffing process is completed, an hunk bamboo bundle mat is obtained; the length, width and thickness of said hunk bamboo bundle mat are 8 m, 450 to 600 mm and 9 to 20 mm respectively, said hunk bamboo bundle mat with netty structure is composed of interlaced bamboo bundles, and comprises the main part, the outer layer and inner layer of said bamboo; the diameter of each bamboo bundles is between 0.1 and 1 mm;
B: drying
the above hunk bamboo bundle mat is dried until the moisture content is 12%;
C: glue spreading
wherein the adhesive is isocyanate adhesive, the spray glue method is used, and the glue spread amount is 8% of the oven dry weight of said hunk bamboo bundle mats; the above isocyanate adhesive is sprayed uniformly on both outer layer and inner layer of said hunk bamboo bundle mats according to the above glue spread amount;
D: assembling
the release agent is daubed on the mold and inner surface of mould provided by the patent ZL 200520003535.0, the hunk bamboo bundle mats are weighed out according to the designed density, and the above glued hunk bamboo bundle mats are laid up horizontal and uniformly in the mould (as shown in FIG. 4) provided by the patent ZL 200520003535.0;
E: curing forming
the cold-pressing and hot-curing technology is used, the cold pressure is 12 MPa; the mold is pressed to the position of pin hole, after the pin is plugged, then the panel and mould after cold-pressed are put into the 140° C. oven, the curing time is 3 h;

Finally, the bamboo scrimber as shown in FIG. 5 is obtained after demoulding.

The above bamboo scrimber is tested by reference to the GB 17657-1999-test methods of evaluating the properties of wood-based panels and surface decorated wood-based panels, the result is as shown in Table 1.

### Comparative Example

The traditional method for manufacturing bamboo scrimbers is used, the green Phyllostachys pubescens, is sawn into 2 m bamboo tubes which are then split into several bamboo sheets. After removing the outer layer and inner layer of said bamboo, the bamboo sheets are fluffed into netty structural bundles by a pressure wire machine.

Other processes are the same as Example 1.

TABLE 1
The Mechanical Properties of the Bamboo Scrimber

| | Glue | | Modulus | Modulus | Internal |
|---|---|---|---|---|---|
| | spread | | of | of | Bond |
| | amount | Density | Elasticity | Rupture | Strength |
| Item | (%) | (g/cm³) | (MPa) | (MPa) | (MPa) |
| Comparative | 11.0 | 1.15 | 17698 | 185.54 | 2.45 |
| Example | | | | | |
| based on | 11.0 | 1.15 | 17873 | 184.67 | 2.35 |
| Phyllostachys | | | | | |
| pubescens | | | | | |
| based on | 8.0 | 1.05 | 13117 | 129.59 | 2.45 |
| Dendrocalamus | | | | | |
| sinicus | | | | | |
| based on | 14.0 | 0.95 | 11435 | 95.51 | 0.87 |
| Dendrocalamopsis | | | | | |
| oldhami | | | | | |

As shown in Table 1, the method provided by the present invention is used to manufacture the bamboo scrimber without removing the outer layer and inner layer of said bamboo, and the properties of said bamboo scrimber are similar with that of the bamboo scrimber made by the traditional method, but in the present patent, the process of removing the outer and inner layer of said bamboo is eliminated, and both the production efficiency and utilization of said bamboo are increased.

### Example 2

The large-diameter and thick-wall bamboos such as Phyllostachys puhescens, Dendrocalamus sinicus and Dendrocalamopsis oldhami are used to make hunk bamboo bundle mat plywoods.

A: the hunk bamboo bundle mat preparation
wherein the bamboo are sawn into a 2.5 m or 1.3 m bamboo tube, which is then split longitudinally into two semicircular bamboo tubes along the diameter, the semicircular bamboo tube is pushed into the fluffer to fluff the inner layer of said bamboo; the fluffing treatment is similar to that in Example 1.
8: drying
the above hunk bamboo bundle mat is dried until the moisture content is 12%;
C: glue spreading
wherein the adhesive is phenolic-formaldehyde adhesive; the dipping glue method is used, the solid content of the phenolic-formaldehyde adhesive is 12% of the oven dry weight of said hunk bamboo bundle mat, the temperature of the glue solution is normal temperature while dipping, and the dipping glue time is 6 min; after the glued hunk bamboo bundle mat are taken out and placed vertically for 6 min until the adhesive on the surface stops dropping; then the glued hunk bamboo bundle mat are dried in 40° C. oven until the moisture content is 2%;
D: assembling
wherein the hunk bamboo bundle mat are weighed out according to the designed density; and the hunk bamboo bundle mats with the length of 2.5 m are spliced into bamboo mat veneers with the width of 1.3 m by transverse splicing, and the above spliced bamboo mat veneers are laid up along the grain direction; the hunk bamboo bundle mats with the length of 1.3 m are spliced into bamboo mat veneers with the width of 2.5 m by transverse splicing, and the above spliced bamboo mat veneers are laid up along the cross striations direction; the above laid up veneers are assembled with adjacent layers cross-structure and with the inner layer inward and outer layer outward (see FIG. 2);
E: hot-pressing
in the above hot-pressing process, the hot-pressing temperature is 150° C., the hot-pressing pressure is 5 MPa and the hot-pressing time is 1.0 ml/mm.

The above bamboo scrimber plywood is tested by reference to the national standard GB/T 19536-2004-test methods of evaluating the properties of the plywood for container flooring; the result is shown in Table 2.

As shown in Table 2, without removing the outer layer and inner layer of said bamboo, the physical and mechanical properties of container flooring provided by the present invention can meet or exceed the requirement of the plywood for container flooring.

TABLE 2
The Mechanical Properties of the Bamboo Plywood

| | Glue | | | | | | |
|---|---|---|---|---|---|---|---|
| | spread | | Modulus of Elasticity | | Modulus of Rupture | | Bond |
| | amount | Density | (MPa) | | (MPa) | | Strength |
| Item | (%) | (g/cm³) | Longitudinal | Traverse | Longitudinal | Traverse | (MPa) |
| China national | — | ≧0.75 | ≧10000 | ≧3500 | ≧85.0 | ≧35.0 | ≧1.70 |
| standard | | | | | | | |
| based on | 11.0 | 1.15 | 11560 | 5600 | 89 | 56 | 1.87 |
| Phyllostachys | | | | | | | |
| pubescens | | | | | | | |
| based on | 8.0 | 1.05 | 11210 | 5400 | 85 | 48 | 1.56 |
| Dendrocalamus | | | | | | | |
| sinicus | | | | | | | |
| based on | 14.0 | 0.95 | 11340 | 5500 | 84 | 52 | 1.67 |
| Dendrocalamopsis | | | | | | | |
| oldhami | | | | | | | |

### Example 3

The small-diameter and thin wall thickness bamboos such as Neosinocalamus affinis, Phyllostachys praecox and Bambusa multiplex are used to manufacture the hunk bamboo bundle mat plywood.

A: the hunk bamboo bundle mat preparation
wherein the small-diameter bamboos such as Neosinocalamus affinis, Phyllostachys praecox and Bambusa multiplex are sawn into a 2.5 m or 1.3 m bamboo tube, which is then longitudinally split into two semicircular bamboo tubes along the diameter; the semicircular bamboo tube is pushed into the fluffer to fluff the inner surface of said bamboo with the inner surface towards the fluffing roller and the outer surface towards the driving roller, after fluffing for 3 times, a series of dotted and/or linear shaped cracks are made on the inner layer of said bamboo by longitudinal cutting and transverse spreading, however, the outer layer of said bamboo still keep relatively complete piece-shape structure, then the structure of semicircular bamboo tubes is converted from the structure with the outer and inner surface of said bamboo as outer arc and inner arc surface respectively into the structure with the inner surface and outer surface of said bamboo as outer arc and inner are surface respectively; the said semicircular bamboo is pushed into the fluffer to fluff the outer surface of said bamboo with the outer surface towards the fluffing roller and the inner surface towards the driving roller, after the fluffing repeated for 3 times, the arc structures of said semicircular bamboo tube faces towards the inner layer of said bamboo again with the further increase of the fluffing degree of the outer layer; repeating above alternate fluffing for 2 times, the fluffing process is completed, an oriented hunk bamboo bundle mat is formed;
the length, width and thickness of said hunk bamboo bundle mat are 2.5 m or 1.3 m, 250 to 400 mm and 2 to 5 mm, respectively; said hunk bamboo bundle mat with netty structure is composed of interlaced bundles, which comprises the main part, outer layer and inner layer of said bamboo. The diameter of each bamboo bundles is between 0.1 mm to 1 mm;
B: drying
wherein the above hunk bamboo bundle mats are dried until the moisture content is 8 to 15%;
C: glue spreading
wherein the adhesive is isocyanate adhesive, the spray glue method is used, and the glue spread amount is 12% of the oven dry weight of said hunk bamboo bundle mats; the above isocyanate adhesive is sprayed uniformly on both outer layer and inner layer of hunk bamboo bundle mats according to the above glue spread amount;
D: assembling
wherein the hunk bamboo bundle mat are weighed out according to the designed density, two Neosinocalamus affinis bundle mats are used as one layer with the bamboo inner layer inward and the bamboo outer layer outward (the wall thickness of Neosinocalamus affinis is thin, so two hunk bamboo bundle mats are used as one layer in order to reduce the deviation of the density in the layer); The hunk bamboo bundle mats with the length of 2.5 m are spliced into the bamboo bundles mat veneers with the width of 1.3 m by transverse splicing, and the above spliced bamboo mat veneers are laid up along the grain direction; the hunk bamboo bundle mats with the length of 1.3 m are spliced into the bamboo bundles mat veneers with the width of 2.5 m, and the above spliced bamboo mat veneers are laid up along the cross striations direction; the hunk bamboo bundle mat in each layer is assembled with cross-structure (see FIG. 2).
E: hot-pressing
wherein the release agent is daubed on hot platen of the mould, the above slab is sent into the hot press, the hot-pressing process is as follows, the hot-pressing temperature is 110° C., the hot-pressing pressure is 5 MPa and the hot-pressing time is 0.9 min/mm;
or, if the said adhesive used is phenolic-formaldehyde adhesive with the solid content of 25%, the solid content of the phenolic-formaldehyde adhesive is 14% of the oven dry weight of said hunk bamboo bundle mat with dipping glue method used, the temperature of the glue solution is normal temperature while dipping, and the dipping glue time is 6 min; after the glued hunk bamboo bundle mats are taken out and placed vertically for 10 min until the adhesive in the surface stops dropping; the above bamboo bundle mats are dried in 50° C. oven until the moisture content is 12%;
the hunk bamboo bundle mat are weighed out according to the designed density, and the above glued hunk bamboo bundle mats are laid up in the mould provided by the patent ZL 200520003535.0 along the grain direction, i.e., the hunk bamboo bundle mat in each layer are laid up in the mould with parallel to the texture of the bamboo bundle;
F: curing forming
the cold-pressing and hot-curing technology is used, the cold pressure is 13 MPa; the mold is pressed to the position of pin hole, after the pin is plugged, then the slab and mould are sent into the 140° C. oven, the curing time is 3 h; the slab and mould are taken out, and the slab is demoulded.

The above bamboo scrimber is tested by reference to the national standard GB/T 17657-1999-test methods of evaluating the properties of wood-based panels and surface decorated wood-based panels, the result is as shown in Table 3.

As shown in Table 3, the small-diameter bamboo such as Neosinocalamus affinis, Phyllostachys praecox and Bambusa multiplex are used to manufacture bamboo scrimber, the properties of the scrimber are similar with that of the bamboo scrimber in the comparative example of Table 1 which are made by the bamboo bundle with the inner and outer layer of said bamboo removed The source of raw materials for bamboo-based panels is expanded, the small-diameter bamboo which are not fully used before can be fully used.

TABLE 3
The Mechanical Properties of Bamboo Scrimber

| | Glue | | Modulus | Modulus | Internal |
|---|---|---|---|---|---|
| | spread | | of | of | Bond |
| | amount | Density | Elasticity | Rupture | Strength |
| Item | (%) | (g/cm³) | (MPa) | (MPa) | (MPa) |
| comparative | 11.0 | 1.15 | 17698 | 185.54 | 2.45 |
| example | | | | | |
| based on | 6.0 | 1.16 | 17378 | 184.67 | 4.38 |
| Neosinocalamus | | | | | |
| affinis | | | | | |
| based on | 8.0 | 1.17 | 17311 | 179.59 | 4.58 |
| Phyllostachys | | | | | |
| praecox | | | | | |
| based on | 10.0 | 0.90 | 14357 | 125.51 | 3.56 |
| Bambusa | | | | | |
| multiplex | | | | | |

### Example 4

A: hunk bamboo bundle mat preparation
wherein the Phyllostachys pubescens and Neosinocalamus affinis are used to prepare the hunk bamboo bundle mat as Example 1 and Example 3 respectively;
B: drying
wherein the above hunk bamboo bundle mats are dried until the moisture content is from 8 to 15%;
C: glue spreading
wherein the adhesive is isocyanate adhesive, the spray glue method is used, and the glue spread amount is 12% of the oven dry weight of said hunk bamboo bundle mats; the above isocyanate adhesive is sprayed uniformly on both outer layer and inner layer of oriented hunk bamboo bundle mats according to the above glue spread amount;
D: assembling
wherein the hunk bamboo bundle mat are weighed out according to the designed weight; each Phyllostachys pubescens bundle mat is used as one layer; two Neosinocalamus affinis bundle mats are used as one layer, because of the thin wall thickness of Neosinocalamus affinis, two Neosinocalamus affinis bundle mats are used as one layer in order to reduce the deviation of the density in the layer; the bamboo bundle mats in each layer are assembled with cross-structure;
E: hot-pressing
wherein the release agent is daubed on hot platen of the mould, the above slab is sent into the hot press, the hot-pressing process is as follows, the hot-pressing temperature is 110° C., the hot-pressing pressure is 5 MPa and the hot-pressing time is 0.9 min/mm.

The above Neosinocalamus affinis plywood is tested by reference to the national standard GB/T19536-2004-test methods of evaluating the properties of the plywood for container flooring, the result is as shown in Table 4. As shown in Table 4, the physical and mechanical properties of said bamboo based panel made from Neosinocalamus affinis can meet or exceed the requirement of the plywood for container flooring.

The above Phyllostachys pubescens plywood is tested according to the industry standard LY/T1574-2000-test methods of evaluating the properties of the bamboo plywood for concrete formwork, the result is shown in Table 5. As shown in Table 5, the physical and mechanical properties of the bamboo plywood for concrete formwork made by the Phyllostachys pubescens bundle mat can meet or exceed the highest requirement for concrete formwork, i.e., 70#.

TABLE 4
The Mechanical Properties of the bamboo plywood based on Neosinocalamus affinis

| | Glue spary | | Sheet | | Modulus of Elasticity | | Modulus of Rupture | | Bond |
|---|---|---|---|---|---|---|---|---|---|
| | amount | Density | Thickness | Impregnated | (MPa) | | (MPa) | | Strength |
| Item | (%) | (g/cm³) | (mm) | stripping | Longitudinal | Traverse | Longitudinal | Traverse | (MPa) |
| China national | — | ≧0.75 | 28 | ≦⅓ length | ≧10000 | ≧3500 | ≧85 | ≧35 | ≧1.70 |
| standard data | | | | of each side | | | | | |
| test data | 5.72 | 0.90 | 28.1 | ≦3 mm | 12000 | 4500 | 90 | 40 | 1.74 |

TABLE 5
The mechanical properties of the bamboo - plywood based on Phyllostachys pubescens

| | | | | | | | | | | | | thickness | |
|---|---|---|---|---|---|---|---|---|---|---|---|---|---|
| | | | | Modulus of | | Modulus of | | Modulus of | | Modulus of | | swelling | |
| | Glue | | Thick- | Elasticity Dry | | Rupture Dry | | Elasticity Wet | | Rupture Wet | | rate of | |
| | spary | | ness | State (MPa) | | State (MPa) | | State (MPa) | | State (MPa) | | water | Bond |
| | amount | Density | swelling | Longi- | | Longi- | | Longi- | | Longi- | | absorption | Strength |
| Item | (%) | (g/cm³) | (%) | tudinal | Traverse | tudinal | Traverse | tudinal | Traverse | tudinal | Traverse | % | (MPa) |
| Attainable | — | — | — | 70# | 70# | 70# | 70# | 70# | 70# | 70# | 70# | Standards | — |
| standard | | | | | | | | | | | | meet | No |
| text data | 7.37 | 0.88 | 8.10 | 93 | 67 | 10326 | 5220 | 72 | 52 | 7567 | 4328 | Standards | separation |
| | | | | | | | | | | | | meet | |

### Example 5

The bamboos such as Phyllostachys pubescens, Dendrocalamus sinicus, Dendrocalamopsis oldhami, Neosinocalamus affinis, Dendrocalamus latiflorus, Phyllostachys praecox and Phyllostachys viridis are used to make bamboo fiber reinforced composites.

The following bamboo fiber reinforced composite is composed of oriented bamboo fiber mat 201 and adhesive layer 202, as shown in FIGS. 9 to 10.

As shown in FIG. 9, the oriented bamboo fiber mat 201 is composed of a series of longitudinal and discontinuous cracks 211 with uneven thickness and longitudinal continuous and netty interlaced fibers 212 with uniform thickness, the cracks and fibers are arranged on the upper surface, lower surface and cylinder wall of semicircular bamboo tubes respectively; the outer and inner layer of said bamboo in the surface of oriented bamboo fiber mat 201 are partly shed, cracked, fragmented or crushed because of cutting, splitting and extruding. The cracks 211 are made by processing the inner arc surface and outer arc surface of the semicircular bamboo tube through fluffer respectively. The fibers 212 are formed between the adjacent cracks 211. The fibers 212 contain 1 to 5 vascular bundles and several ground tissues. The width of the oriented bamboo fiber mat is 2 to 5 times the arc length of the original semicircular bamboo tube 203.

The adhesive layer 2 penetrates into the cracks 211 on the bamboo oriented bamboo fibers mat 212, adhesive layers 202 are and form a thin adhesive layer which is phenolic-formaldehyde adhesive is arranged on the upper, lower and surrounding surface of said bamboo fiber, as shown in FIG. 10.

Due to a series of longitudinal cracks with uneven thickness are distributed uniformly on the oriented bamboo fiber mat in the wide and thick direction of the oriented bamboo fiber mat for the bamboo fiber reinforced composite of the present invention, longitudinal fibers of the original bamboo are not destroyed, and the adhesive layer 202 penetrates uniformly and alternately into the cracks 211 and fibers 212 to form strong plastic nail connection and chemical combination, then the strength, hardness and durability of the original bamboo are all improved effectively.

The physical and mechanical properties of the bamboo fiber reinforced composite in the present invention are shown in Table 6.

TABLE 6
Physical and mechanical properties of
said bamboo fiber reinforced composite

| Density (g/cm³) | 1.1 | 1 | 0.8 |
|---|---|---|---|
| Modulus of Rupture (Mpa) | 288.6 | 253.7 | 156.1 |
| Modulus of elasticity (Mpa) | 28.9 | 24.1 | 16.43 |
| Tensile strength (Mpa) | 274.2 | 256.9 | 157.9 |
| Tensile modulus (Mpa) | 30 | 28.4 | 17.6 |
| Compression strength (Mpa) | 150.9 | 147.8 | 112.3 |

The method for manufacturing the bamboo fiber reinforced composite in typical examples is as follows:

1) the bamboos such as Phyllostachys pubescens, Dendrocalamus sinicus, Dendrocalamopsis oldhamt, Neosinocalamus affinis, Dendrocalamus latiflorus, Phyllostachys praecox and Phyllostachys viridis are sawn into a bamboo tube with the length of 1.5 to 20 m, which is then longitudinally split into two semicircular bamboo tubes 3 along the diameter, and the inner nodes of semicircular bamboo tubes are removed;
2) the inner arc surface of semicircular bamboo tubes fluffing
wherein as shown in FIG. 11, the end of the semicircular bamboo tube is pushed into the clearance between drive roller and fluffing roller with its inner surface towards the fluffing roller, as several uniformly distributed fluffing teeth 251 with cutting edges are arranged on the outer circumference of said fluffing roller 205, wherein the length of fluffing teeth is 1.1 to 3 times the longitudinal distance between the teeth and the height is 0.5 to 0.75 times said semicircular bamboo wall thickness, while the driving roller 204 is dragging the semicircular bamboo tube 203 in parallel, a series of uniform and discontinuous cracks 211 are formed on the inner arc surface of the semicircular bamboo tube 203 by local longitudinal cutting and transversal extruding the different position in the inner arc surface of said semicircular bamboo tube with the said fluffing teeth 251, however, the outer surface of the semicircular bamboo tube remains relatively complete piece-shape structure, as shown in FIG. 3; said semicircular bamboo tube is fluffed for several times with the above method;
meanwhile, during the fluffing process by combining the fluffing teeth 251 and the driving roller 204, wherein the convex roller is used as the driving roller, the inner arc surface of semicircular bamboo tubes 203 are cut, split and extruded so as to be partly shed, cracked, fragmented or crushed; such defect as poor wettability and low bonding performance of the silicon in the inner layer can be overcame, then the bonding performance can be improved;
however, the outer layer of the semicircular bamboo tube still remains relatively complete piece-shape structure, so the structure of semicircular bamboo tube is converted from the structure with the outer and inner surface of said bamboo as outer arc and inner arc surface respectively into the structure with the inner surface and outer surface of said bamboo as outer and inner arc surface respectively; so that the tensile force formed on the inner surface and extrusion force formed on the outer surface contribute to shed the outer and inner layer of said bamboo;
3) the outer arc surface of semicircular bamboo tubes fluffing
as for the semicircular bamboo tube 203 with the fluffed inner arc surface, the outer surface still remains relatively complete piece-shape structure, and the structure of semicircular bamboo tubes is converted from the outer and inner surface of said bamboo as outer arc and inner arc surface respectively to the inner surface and outer surface of said bamboo as outer arc and inner arc surface respectively;
then, said semicircular bamboo tube 203 with the fluffed inner arc surface turns 180 degrees, i.e. the corresponding outer arc surface of original semicircular bamboo tubes faces towards said fluffing roller 205 of the above fluffer or the same fluffer as the above, one end of the semicircular bamboo tube 203 is pushed into the clearance between, driving roller 204 and fluffing roller 205, with the same procedure as the above, uniform and discontinuous cracks 211 are formed on the corresponding outer arc surface of original semicircular bamboo tubes, with above method, said semicircular bamboo tube is fluffed for several times;
meanwhile, during the fluffing process by combining the fluffing teeth 251 and the driving roller 204, wherein the driving roller is with uniform convex pocks on its surface, the waxy layer on the outer layer of semicircular bamboo tubes 203 is cut, split and extruded as to be partly shed, cracked, fragmented or crushed, so that such defect as poor wettability and bonding performance of the waxy in the outer layer of said bamboo can be overcome;
besides, after the fluffing in step 2) and 3) repeatly, the above semicircular bamboo tubes 203 is fluffed into oriented bamboo fiber mat in which a series of longitudinal and discontinuous cracks 211 with uneven thickness and longitudinal continuous and netty interlaced fiber 212 with uniform thickness is arranged in the width and thickness direction; the fibers 212 contain 1 to 5 vascular bundles and several ground tissues, and the width of the oriented bamboo fiber mat 201 is 2 to 5 times the arc length of the original semicircular bamboo 203; thus, the main part of said bamboo with good bonding performance is exposed to the outer arc surface, the effective bamboo bonding area is effectively increased and the impregnation path of said bamboo is greatly improved;
4) drying
wherein the said fluffed oriented bamboo fiber mat is dried in the oven or in the air until the moisture content is a range of 8 to 15%;
5) glue spreading
wherein if said adhesive is phenol-formaldehyde resin, the solid content is 10 to 25%, the solid content of the phenol-formaldehyde adhesive is 8 to 20% of the oven dry weight of the oriented bamboo fiber mat with dipping glue process; while the oriented bamboo fiber mats are dipping glue, the temperature of the glue solution is normal temperature while dipping, and the dipping glue time is 5 to 10 min, then the oriented bamboo fiber mats are taken out and placed vertically for 5 to 10 min until the adhesive stops dropping; then the above glued oriented bamboo fiber mats are dried in the oven with the temperature of 40 to 60° C. until the moisture content is a range of 6 to 12%;
6) assembling
wherein the oriented bamboo fiber mats are weighed out according to the designed density, generally, the above glued oriented bamboo fiber mats are assembled with parallel or cross structure with the outer layer outward and the inner layer inward so as to form a slab;
or, the oriented bamboo fiber mats are weighed out according to the designed density, and the above glued oriented bamboo fiber mats are uniformly laid up in the mould;
7) hot-pressing
the cold-in and cold-out technology is used in the hot-pressing; when the temperature of the hot platen is in a range of 40 to 60° C., the above slab is sent into the press; the superheated vapor is introduced into the presser, and the pressure is increased while the temperature is increased; when the pressure is 3.5 Mpa, the pressure is kept, and when the temperature is 160° C., the temperature is kept, the holding time of the temperature is 0.5 min/mm; then the cold water is introduced into the press to decrease the temperature to 40 to 60° C.; the pressure is released, and the slab is taken out from the press to obtain the needed assembly product of several bamboo fiber reinforced composites;
or the cold-pressing and hot-curing technology is used, the oriented bamboo fiber mats are cold pressed with 8 to 13 MPa in the mould; when the mould is pressed to the position of pin hole, the mould is locked by the pin, then the above mould and slab is sent into the oven with the temperature of 140 to 160° C. and cured for 3 to 5 h, after the mould and slab are taken out, the slab is demoulded.

1. A bamboo-based panel made by hunk bamboo bundle mat, comprising several layers of the hunk bamboo bundle mats with the width of 50 to 600 mm, wherein the adjacent hunk bamboo bundle mats are assembled with parallel or cross structure along the grain direction, the glue layers are arranged between the adjacent hunk bamboo bundle mats and between the bamboo bundles of the hunk bamboo bundle mat so as to make bamboo-based panels by gluing; for said hunk bamboo bundle mat, a series of dotted and/or linear shaped cracks are formed on the cylinder wall of a semicircular bamboo tube which is split and inner nodes are removed from so as to form netty structural hunk bamboo bundle mat, said hunk bamboo bundle mat comprises the outer layer, the main part and the inner layer of said bamboo, and the upper surface and the lower surface of said hunk bamboo bundle mat comprise the outer layer and inner layer of said bamboo, wherein, a waxy layer and a siliceous layer are respectively removed therefrom.

2. A bamboo-based panel made by hunk bamboo bundle mat according to claim 1, wherein the two hunk bamboo bundle mats with the inner surface of said bamboo jointed relatively or one hunk bamboo bundle mat are used as the symmetrical center, the other hunk bamboo bundle mats are assembled symmetrically with all the inner surfaces of said bamboos towards the symmetrical center.

3. A bamboo-based panel made by hunk bamboo bundle mats according to claim 1, wherein the width of said hunk bamboo bundle mat is 2 to 5 times the arc length of said original split semicircular bamboo tube according to the density of said cracks in said hunk bamboo bundle mat.

4. A bamboo-based panel made by hunk bamboo bundle mats according to claim 1, wherein the bamboo bundles are formed between the adjacent cracks, and the diameters of said bamboo bundles between the adjacent two said cracks is 0.1 to 5 mm.

5. A bamboo-based panel made by hunk bamboo bundle mats according to claim 1, wherein the adhesive used in said glue layer is phenolic-formaldehyde adhesive, and the glue spread amount is 8% to 40% of the oven dry weight of the hunk bamboo bundle mats.

6. A bamboo-based panel made by hunk bamboo bundle mats according to claim 1, wherein the adhesive used in said glue layer is isocyanate adhesive, and the glue spread amount is 8% to 40% of the oven dry weight of the hunk bamboo bundle mats.

7. A bamboo fiber reinforced composite, comprising the oriented bamboo fiber mats and adhesive layers, serial of longitudinal and discontinuous cracks with uneven thickness are distributed on the upper surface, lower surface and bamboo wall of oriented bamboo fiber mats, and the glue layers are arranged among the cracks and on the surfaces of said bamboo fiber mats.

8. A bamboo fiber reinforced composite according to claim 7, wherein the fibers are formed between adjacent said cracks, said fiber contains 1 to 5 vascular bundles and several ground tissues.

9. A method for manufacturing said bamboo-based panel made by the hunk bamboo bundle mat, comprising the following steps:
A. the hunk bamboo bundle mat preparation
wherein the bamboo is sawn into a bamboo tube with the given length, which is then longitudinally split into two semicircular bamboo tubes, after the inner nodes removed, the semicircular bamboo tube is fed into the fluffer along the grain direction, the bamboo tube is fluffed along the longitudinal fiber direction to form a series of dotted and/or linear shaped cracks along the fiber direction; the bundles with connection part and separation part between them are formed, and the natty structural hunk bamboo bundle mat is formed by the interlaced bamboo bundles, which comprises the main part, outer layer and inner layer of said bamboo, and the upper surface and the lower surface of said hunk bamboo bundle mat comprise the outer layer and the inner layer of said bamboo, wherein, a waxy layer and a siliceous layer are respectively removed therefrom;
B. drying
wherein said hunk bamboo bundle mat is dried until the moisture content is in a range of 8 to 15%;
C. glue spreading
wherein the glue is spread on said hunk bamboo bundle mat;
D. assembling
wherein the said glued hunk bamboo bundle mats are weighed out according to the designed density, and then assembled;
E pressing forming
wherein the hunk bamboo bundle mats which are assembled in the assembling step are put in the press to form the bamboo-based panels.

10. A method for manufacturing bamboo-based panels made by hunk bamboo bundle mats according to claim 9, wherein the adhesive used in glue spreading procedure is isocyanate, the glue spread amount is 5 to 20% of the oven dry weight of the hunk bamboo bundle mats, and the above isocyanate adhesive is sprayed uniformly on both outer layer and inner layer of oriented hunk bamboo bundle mats by spray glue according to the weight of said hunk bamboo bundle mat.

11. A method for manufacturing bamboo-based panels made by hunk bamboo bundle mats according to claim 9, wherein the hot-pressing is used in said forming procedure, and the glued hunk bamboo bundle mats in adjacent layers are assembled with parallel or cross structure in said assembling procedure, then the assembled hunk bamboo bundle mats are hot-pressed; the hot-pressing temperature is 90 to 130° C., the hot-pressing pressure is 5 to 20 MPa, and the hot-pressing time is 0.5 to 2 min/mm; or the cold-pressing and hot-curing process is used in said forming procedure, and the glued hunk bamboo bundle mats are assembled along the grain direction, i.e., the hunk bamboo bundle mat in each layer is assembled as parallel to the grain of the bamboo bundle, and laid up in the mould in said assembling procedure; the cold-pressing pressure is 5 to 15 MPa, the temperature is room temperature, after the slab is pressed to the designed position, the mould is fixed with pins, then the slab with mould is dried in the oven for 1.5 to 3 h at 90 to 140° C.

12. A method for manufacturing bamboo-based panels made by hunk bamboo bundle mats according to claim 9, wherein the adhesive used in the glue spreading procedure is phenol-formaldehyde resin adhesive, the glue spread amount is that, the solid content of the phenol-formaldehyde is 8˜40% of the oven dry weight of the hunk bamboo bundle mats.

13. A method for manufacturing bamboo-based panels made by hunk bamboo bundle mats according to claim 9 wherein the dipping glue method used is that, the hunk bamboo bundle mats are immersed in the phenol-formaldehyde resin with the solid content of the phenol-formaldehyde resin adhesive is 8 to 30%, the temperature of the glue solution is normal temperature while dipping glue, and the dipping glue time is 5 to 20 min, then the glued hunk bamboo bundle mats are taken out and placed vertically for 5 to 20 min until the adhesive stop dripping.

14. A method for manufacturing bamboo-based panels made by hunk bamboo bundle mats according to claim 9 wherein the hot-pressing is used in said forming procedure, and the glued hunk bamboo bundle mats in adjacent layers are assembled with parallel or cross structure in said assembling procedure, then the assembled hunk bamboo bundle mats are hot-pressed; the hot-pressing temperature is 130 to 180° C., the hot-pressing pressure is 5 to 15 MPa, and the hot-pressing time is 0.5 to 2 min/mm; or the cold-pressing and hot-curing process are used in said forming procedure, and the glued hunk bamboo bundle mats are assembled along the grain direction, i.e., the hunk bamboo bundle mat in each layer is assembled as parallel to the grain direction of the bamboo bundle, and laid up in the mould in said assembling procedure; the slab and mould are sent into the press, the pressure is 10 to 15 MPa, the temperature is room temperature, after the slab pressed to the designed position, the mould is fixed with pins, then the slab with mould are dried in the oven for 2 to 4 h at 120 to 180° C.

15. A method for manufacturing bamboo-based panels made by hunk bamboo bundle mats according to claim 10, wherein it is needed to coat the release agent on the mould or the hot platen of the hot press when the isocyanate is used as adhesive.

16. A process for manufacturing the bamboo fiber reinforced composites according to claim 7, comprising the following steps:
A: the bamboo is transversally cut into a bamboo tube with the length of 1.5 to 20 m, which is then longitudinally split into two semicircular bamboo tubes along the diameter, and the inner nodes of the semicircular bamboo tube are removed;
B: the inner arc surface of the semicircular bamboo tube fluffing
wherein on end of the semicircular bamboo tube is pushed into the clearance between driving roller and fluffing roller with its inner arc surface towards the fluffing roller; while the driving roller is dragging the semicircular bamboo tube parallelly forward, a series of longitudinal cracks with uneven thickness are arranged discontinuously on the inner arc surface by the local longitudinal cutting and transversal extruding of the different position in the inner arc surface of said semicircular bamboo tube, however, the outer surface of the semicircular bamboo tube still remains relatively complete piece-shape structure, meanwhile, the siliceous layer in the inner surface of the semicircular bamboo tube is cut, split and extruded by the fluffing roller and the outer surface is frictionized by the driving roller, then the waxy layer and the siliceous layer of semicircular bamboo tubes are partly shed, cracked, fragmented or crushed; said semicircular bamboo tube is fluffed for several times with the above method;
C: the outer arc surface of the semicircular bamboo tube fluffing
wherein said semicircular bamboo tube with fluffed inner arc surface turns 180 degrees, which is pushed into the clearance between the driving roller and fluffing roller with the outer surface towards the above fluffing roller or the fluffing roller of the same fluffer as the above, with the same procedure as step B, a series of longitudinal and discontinuous cracks with uneven thickness are arranged on the outer arc surface of the corresponding original semicircular bamboo tubes, meanwhile, the siliceous layer in the outer surface of semicircular bamboo tubes is cut, split and extruded by the fluffing roller and the inter arc surface is frictionized by the driving roller, the waxy layer and the siliceous layer of said semicircular bamboo tube are partly shed, cracked, fragmented or crushed; with above method, said semicircular bamboo tubes is fluffed for many times;
repeating step B and step C to fluff the semicircular bamboo tube for several times, a series of discontinuous and longitudinal cracks with uneven thickness and a series of longitudinal and continuous fibers with uniform thickness are formed on the outer surface, inner surface and cylinder wall of semicircular bamboo tubes respectively, said cracks and said fibers are interlaced to form netty structural oriented bamboo fiber mat;
D: drying
wherein the said fluffed oriented bamboo fiber mat is dried in the oven or in the air until the moisture content is at 8 to 15%;
E: glue spreading
if said adhesive is phenol-formaldehyde resin, the solid content is 10 to 25%, the solid content of the phenol-formaldehyde adhesive is 8 to 20% of the oven dry weight of the oriented bamboo fiber mat with dipping glue process; while the oriented bamboo fiber mats are dipping, the temperature of the glue solution is normal temperature while dipping, and the dipping glue time is 5 to 10 min, then the oriented bamboo fiber mats are taken out and placed vertically for 5 to 10 min until the adhesive stop dropping; then the glued oriented bamboo fiber mats (OBFM) are dried in the oven with the temperature of 40 to 60° C. until the moisture content is 6 to 12%;
F: assembling
wherein the oriented bamboo fiber mats are weighed out according to the designed density, then the above glued oriented bamboo fiber mats are assembled with parallel or cross structure, the outer layer outward and the inner layer inward so as to form the slab;
or, the oriented bamboo fiber mats are weighed out according to the designed density, and uniformly assembled in the mould;
G: hot-pressing
the cold-in and cold-out technology is used in the hot-pressing process, when the temperature of the hot platen is in a range of 40 to 60° C., the above slab is pushed into the hot-press; the superheated vapor is fed, the pressure is increased while the temperature is increased; when the pressure is 3.5 Mpa, the pressure is kept, and when the temperature is 160° C., the temperature is kept, and the holding time of the temperature is 0.5 min/mm; then the cold water is fed into the press to decrease the temperature to 40 to 60° C., the pressure is released, and the slab is taken out from the press to obtain the needed assembly product of several bamboo fiber reinforced composite;
or the cold-pressing and hot-curing technology is used, the oriented bamboo fiber mats are cold pressed with 8 to 13 MPa in the mould; when the slab is pressed to the designed position, the mould is fixed with the pin, then the above mould with slab is sent into the oven with the temperature of 140 to 160° C. and cured for 3 h ˜5 h, after the mould is taken out, the slab is demoulded.

17. A process for manufacturing the bamboo fiber reinforced composites according to claim 16, wherein the length of the fluffing teeth is 1.1 to 1.3 times longitudinal distance between the two teeth, and the height of said fluffing teeth is 0.5 to 0.75 times the wall thickness of the semicircular bamboo tube.

18. A process for manufacturing the bamboo fiber reinforced composites according to claim 16, wherein the width of said oriented bamboo fiber mats extends to 2 to 5 times the arc length of the semicircular bamboo
